(19) United States
(12) Patent Application Publication
(10) Pub. No.: US 2010/0311265 A1
(43) Pub. Date: Dec. 9, 2010

(54) PLUG CONNECTOR FOR PHOTOVOLTAIC CABLE SETS

(76) Inventors: Michael Stracke, Balve (DE); Stefan Joergens, Schalksmuehle (DE)

Correspondence Address: KF ROSS PC, 5683 RIVERDALE AVENUE, SUITE 203 BOX 900, BRONX, NY, 10471-0900, US

(21) Appl. No.: 12/593,409

(22) PCT Filed: Jan. 11, 2008
(86) PCT No.: PCT/DE2008/000050

§ 371 Date: Sep. 29, 2009

(30) Foreign Application Priority Data
Dec. 15, 2007 (DE) 10 2007 060 574.0

(51) Int. Cl. H01R 13/627

(52) U.S. Cl. 439/345

(57) ABSTRACT

The invention relates to a plug connector (10) with a plug (11) which has a handle element (13), a contact support (14) and at least one snap-in lug (16) pointing in the insertion direction, said lug has a snap hook (18) pointing toward the outside of the plug, and with a bushing (12) which has a handle element (21), a contact support holder (20) and at least one snap-in tunnel (22) corresponding to the snap-in lug (16) on the plug side, which is part of the handle element (21) and ends in a snap-in groove (23) arranged around the outer perimeter of the handle element (21), wherein in the inserted state of plug (11) and bushing (12), the snap-in lug passes through the snap-in tunnel and the snap-in hook engages behind the snap-in tunnel which secures the connected state. The purpose of the invention is to create a plug connector suitable for future safety requirements but which can be combined with existing plug connector components. This problem is solved by a plug connector with the characterizing features, wherein the snap-in tunnel side walls (25) extend into the region of the snap-in groove and the snap-in groove bounded on the side in this manner, is converted into a snap-in recess open toward the outside of the plug connector.

The invention relates to a plug-type connector, particularly for photovoltaic cable sets, comprising a plug having a grip, a contact support, and at least one snap-in tongue extending in an insertion direction and carrying a snap-in barb pointing toward a plug outer face, and a socket having a grip, a contact-support seat, and at least one snap-in hole generally complementary to the snap-in tongue of the plug, formed in the grip, and ending in a snap-in groove open outward toward an outer surface of the grip, wherein in a plugged-in condition of the plug and the socket the snap-in tongue extends through the snap-in hole and the snap-in barb engages behind the snap-in hole to lock the connected condition.

Generic plug-type connectors are already well known from the prior art, although not verifiably published, but obviously used by the applicant.

Solar systems and solar power plants usually comprise a plurality of solar panels generating electricity. The solar panels have output cable sets that transmit the electricity generated to the power transfer point via various technical devices. For reasons of installation ease it is common to prefit the solar panels with a connection set for connection to a line that receives the electricity of several solar panels via their respective plug-type connectors.

For reasons of operational safety, high demands are placed on the reliability of the known plug-type connectors. The requirements relate both to a long service life of the parts, such that special plastic types are used, and to assurance that these plug-type connectors do not come open. To this end the plug and socket of the plug-type connector are snapped together.

In a number of generic plug-type connectors such as those produced by the applicant the snap connection may easily be undone in a simple, manual manner in order to separate individual solar panels from the network for maintenance purposes. This is carried out by the user gripping the snap-in grooves with his/her fingers in order to release the snap barbs.

Standards, regulations, and guidelines are increasingly passed serving for the increased safety of solar systems as solar technology develops. For example, it is being considered to no longer permit the manually releasable latching of plug-type connectors in the future. It will become a requirement that plug-type connectors for photovoltaic cable sets must be separated by means of a special tool only.

This creates problems for manufacturers of plug-type connectors for photovoltaic systems, such as for the applicant, having already equipped a number of systems. For a photovoltaic system that is at least more than 25 years old, replacement parts must be provided for at least the same amount of time, which, according to a regulation, therefore render the same out-dated. This requires a significant logistical effort and capital expenditure.

With regard to system operators an added problem is that various different plug-type connectors are being used, having an adverse effect on maintenance, repair, and supplementation of the system, particularly in the case of retrofitting existing systems.

The object of the invention is therefore to create a plug-type connector meeting future safety requirements, which, however, may be combined with plug-type connector parts already used by applicant, wherein snap-in hole side walls extend out to the snap-in groove and laterally close the snap-in groove and convert it into a snap-in recess open toward the outside at the plug outer face.

According to the invention only the socket of the plug-type connector is modified. The snap-in groove, which the thumb and index finger of a hand have previously been easily capable of gripping for releasing the plug, is now narrowed down to a snap-in recess by extension of the snap-in hole side walls into the region of the snap-in groove and bounding its sides. The closing of the sides narrows the snap-in groove such that the plug-type connector can no longer be released, at least not manually, since the snap-in recess provides no room a hand can enter.

In order to further impede access to the snap-in barbs arranged on the snap-in tongues on the plug side, the invention provides that the height of the hole side walls extends up to the outer surface of the socket such that the snap-in recess forms a snap-in window, the embodiment advantageously being further improved in that the snap-in barb is recessed within the snap-in recess short of the plug-type connector outer surface or at most flush.

This surprisingly simple modification of the socket, at least in a retrospective aspect, ensures a complete plug-in compatibility with the current product line produced by applicant, since the existing plug, and particularly the snap-in formations thereof, do not require any changes. The shape of the snap-in formations on the socket, that is to say of the snap-in hole and the snap-in groove where the snap-in barb of the snap-in tongue engages the plug, are not modified. However, with an advantageous plug-in compatibility manual release of the plug-type connector according to the invention is not possible, thus significantly improving safety.

A better understanding of the invention, as well as further advantages, are obvious from the description of an embodiment. Therein:

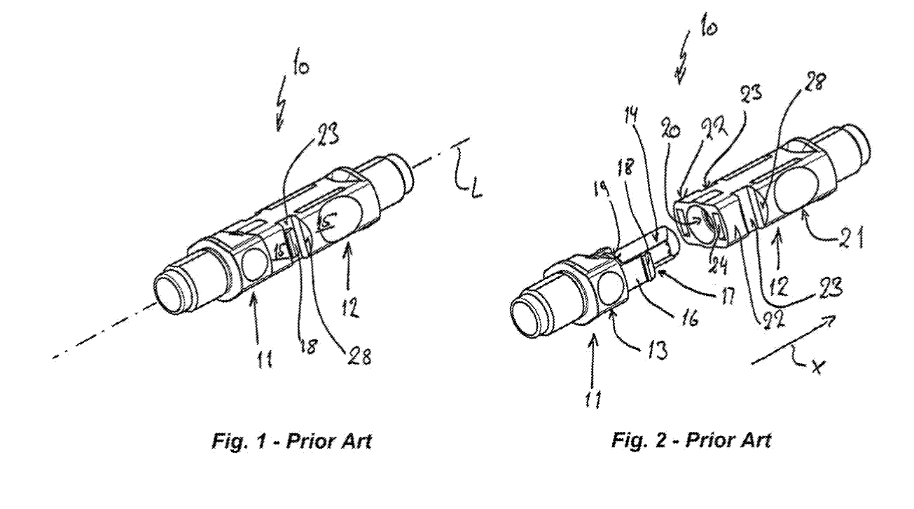

FIG. 1 shows a plug-type connector according to prior art in the plugged-in condition,

FIG. 2 shows the plug-type connector according to FIG. 1 in the unplugged condition,

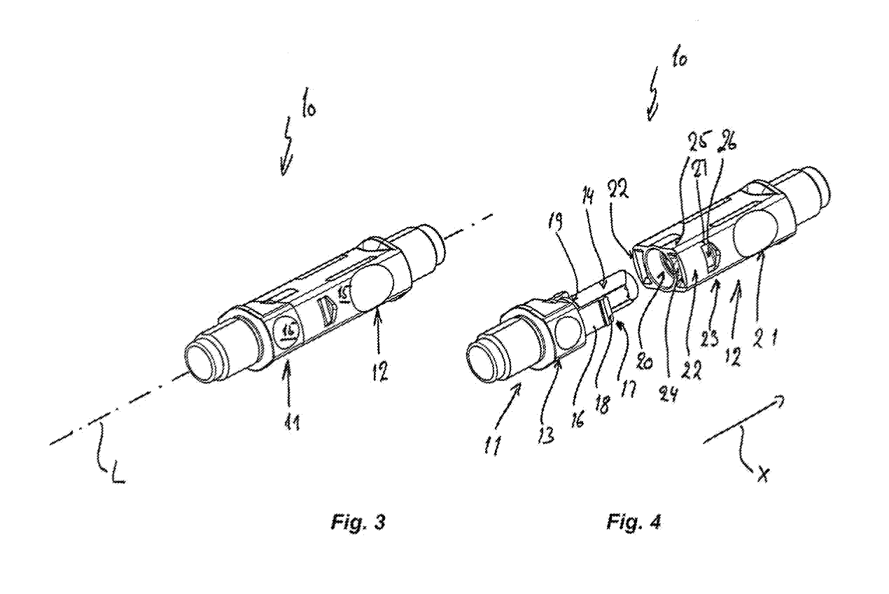

FIG. 3 shows a plug-type connector according to the invention in the plugged-in condition,

FIG. 4 shows the plug-type connector according to FIG. 3 in the unplugged condition.

The drawings show a plug-type connector generally indicate at reference 10. The plug-type connector 10 has a plug 11 and a socket 12, both made from plastic.

The plug 11 has a grip 13 from which a central, tubular contact support 14 projects in an insertion direction x. The grip 13 carries two snap-in tongues 16 diametrally opposite each other, spaced from the contact support 14 toward a plug outer face 15, extending in the insertion direction x, and having outer ends facing the socket 12 from which snap barbs 18 project that point toward the plug outer face 15 or radially outward. A seal 19 is provided at the transition from the grip 13 to the contact support 14 to prevent dirt and moisture from getting into a socket contact-support seat 20.

FIGS. 1 and 2 schematically illustrate a plug-type connector according to the prior art, as distributed by the applicant. Like the plug 11, the socket 12 has a grip 21 that forms the previously mentioned substantially cylindrically shaped central contact-support seat 20 axially open toward the plug 11. At its axial outer end facing the plug 11, the socket 12 has two snap-in holes 22 open toward and alignable with the snap-in tongues 16 of the plug 11 and ending at respective snap-in grooves 23 spaced inward in the insertion direction x. The snap-in holes 22 extend parallel to a plug-type connector longitudinal axis L, however, the snap-in grooves 23 extend in a plane orthogonal to the longitudinal connector axis L. In order to assemble the parts of the plug-type connector 100 illustrated in FIG. 2, that is to say the plug 11 and the socket 12, the contact support 14 of the plug 11 is first plugged into the contact-support seat 20 of the socket 12. The snap-in tongues 16 extending in the direction of the snap-in hole 22 engage into the snap-in hole openings 24 when the plug 11 is plugged into the socket 12.

In the plugged-in condition of the prior-art plug-type connector 10 as illustrated in FIG. 1, the snap-in barbs 18 have passed axially through the respective snap-in holes 22 being deflected elastically radially inward toward the contact support 14 as this happens. After passing through the respective snap-in holes 22 outer ends 17 of the snap-in tongues 16 carrying the snap-in barbs 18 reach the snap-in grooves 23 and the snap-in barbs 18 pass out of the inner ends of the respective the snap-in holes 22 in the insertion direction. Due to the elasticity of the snap-in tongues 16 the snap-in barbs 18 return to their unstressed condition and engage inward of the snap-in hole 22 such that the plugged-in condition of the plug-type connector 10 is locked.

In order to release the plug and socket it suffices according to the prior art to insert the thumb and index finger into the snap-in grooves 23 and unlock the snap-in barbs 18. In order to facilitate this, the snap-in groove 23 has an bevel 28 that angled inward toward the groove base. The plug 11 and socket 12 can then be easily pulled apart, that is to say separated.

FIGS. 3 and 4 illustrate the plug-type connector 10 according to the invention also in the unplugged condition. The same reference numerals are used for functionally analogous parts.

According to the invention no modifications are made to the plug 11 of the plug-type connector 10. The socket 12 of the plug-type connector 10 also remains largely free of any changes. Here however snap-in hole side walls 25 extend up to and define side flanks of the snap-in grooves 23. This creates a seat for the snap-in barbs 18 that is open only toward the plug outer face 15 and that is formed as a snap-in window 26. To this end the radial dimensions of the snap-in hole side walls 25 are such that they end at their outer edges 27 level with the plug outer face 15. The bevel 28 of the prior art is thus omitted.

In order to further narrow the snap-in window 26, e.g. for a further improved protection against manual releasing of the snap-in connection, the opening of the snap-in groove 23 forming the snap-in window 26 and facing toward the plug outer face 15 is partially covered by additional material such that an empty space is created in a region offset rearward in the insertion direction x. Furthermore, the snap-in barb 18 is supported in the snap-in window such that it does not project radially outward past the outer surface 15 of the plug-type connector 10.

In summary the plug-type connector 10 according to invention illustrated in FIGS. 3 and 4 has the substantial advantage manual separation of the plug-type connector 10 is no longer possible due to the configuration of the snap-in groove 23 as a snap-in window 26. However, a particular advantage is that in order to achieve the safety goal, only the socket 12 of the plug-type connector 10 needs to be modified. This makes it possible to continue to utilize the manufacturer's die for the plug 11. On the other hand, the socket 12 remains unchanged from that of the socket 12 according to the prior art (illustrated in FIGS. 1 and 2) with regard to the geometry of the snap-in formations thereof, which are formed as the snap-in holes 22. Consequently, the socket 12 may also be used with the plugs 11 according to the prior art such that the plug-in compatibility with the plug-type connectors 10 manufactured by the applicant thus far is ensured. The outside dimensions of the plug 11 and socket 12 also remain identical to the current plug-type connector such that the plug-type connector according to the invention may also be used as usual in tight installation conditions. This ensures simple maintenance and repair of existing solar systems, or the plug-type connectors used therewith and facilitates the logistics for replacement part supplies both with regard to the plug-type connector manufacturer, and the solar system operators.

1. A plug-type connector for photovoltaic cable sets, comprising
a plug having
a grip,
a contact support, and
at least one snap-in tongue extending in an insertion direction and carrying a snap-in barb pointing toward a plug outer face, and
a socket having
a grip,
a contact-support seat,
at least one snap-in hole generally complementary to the snap-in tongue of the plug, formed in the grip, and ending in a snap-in groove open outward toward an outer surface of the grip, wherein in a plugged-in condition of the plug and the socket the snap-in tongue extends through the snap-in hole and the snap-in barb engages behind the snap-in hole to lock the connected condition, and
snap-in hole side walls extending out to the snap-in groove, laterally closing the snap-in groove, and converting it into a snap-in recess open toward the outside at the plug outer face.

2. The plug-type connector according to claim 1 wherein the contact support on the plug side is a tube extending in the insertion direction and internally holding a plug-in contact.

3. The plug-type connector according to claim 2 wherein the contact-support seat on the socket side has guide surfaces corresponding with guide surfaces of the contact support on the plug side, and enable insertion of the plug into the socket utilizing only the snap-in tongues facing the snap-in holes.

4. The plug-type connector according to claim 1 wherein the snap-in hole side walls extend out to level with the plug outer face of the socket so that the snap-in recess forms a snap-in window.

5. The plug-type connector according to claim 1 wherein the snap-in barb fits within the snap-in recess opposite of the plug-type connector without projecting past the outer surface.

6. The plug-type connector according to claim 1 wherein the plug-type connector is unipolar.

7. In combination with a plug having
a grip extending along an axis,
a contact support projecting axially from the grip, and
a snap-in tongue extending axially adjacent the contact support and having an axial outer end provided with a radially outwardly directed a snap-in barb,
a socket formed with
a grip extending along an axis;
a contact-support seat dimensioned to receive the contact support in a plugged-in condition with the axes generally coaxial;
two axially extending, angularly spaced, and radially projecting side walls having radial outer edges;
an axially and angularly extending outer wall bridging the side walls between the outer edges thereof and defining therewith an axially throughgoing snap-in hole; and
a radially open snap-in recess at an axial inner end of the snap-in hole, between the side walls thereof, and having an annularly continuous radial outer edge entirely flush with an outer surface of the socket grip.

8. The combination defined in claim 7 wherein an inner surface of the recess meets the outer surface of the socket grip at a substantially right angle.
